(19) United States
(12) Patent Application Publication
(10) Pub. No.: US 2022/0010756 A1
(43) Pub. Date: Jan. 13, 2022

(54) AIR SUCTION DEVICE FOR INTERNAL COMBUSTION ENGINE

(71) Applicant: AISIN SEIKI KABUSHIKI KAISHA, Kariya-shi, Aichi (JP)

(72) Inventors: Hideto YANO, Kariya-shi, Aichi (JP); Masato ISHII, Kariya-shi, Aichi (JP); Tomohiro YAMAGUCHI, Kariya-shi, Aichi (JP)

(73) Assignee: AISIN CORPORATION, Kariya-shi, Aichi (JP)

(21) Appl. No.: 17/295,763

(22) PCT Filed: Nov. 6, 2019
(86) PCT No.: PCT/JP2019/043387

§ 371 Date: May 20, 2021

(30) Foreign Application Priority Data
Nov. 22, 2018 (JP) 2018-219723
Nov. 22, 2018 (JP) 2018-219728

(51) Int. Cl. F02M 35/10; F02M 31/135

(52) U.S. Cl. CPC F02M 35/10091; F02M 35/10216; F02M 35/10268; F02M 31/135

(57) ABSTRACT

An air intake apparatus for an internal combustion engine includes an outer port member facing an inner surface of a suction port, an inner port member arranged inside the outer port member, and a heater arranged inside the inner port member. The inner port member is stacked on an outside of the heater in a direction orthogonal to an intake flow direction of the suction port, and is configured to insulate heat from the heater.

### TECHNICAL FIELD

The present invention relates to an air intake apparatus of an internal combustion engine, and more particularly, it relates to an air intake apparatus of an internal combustion engine including a heater.

### BACKGROUND ART

In general, an air intake apparatus of an internal combustion engine including a heater is known. Such an air intake apparatus of an internal combustion engine is disclosed in U.S. Pat. No. 4,807,232, for example.

U.S. Pat. No. 4,807,232 discloses a suction port structure of an internal combustion engine including a resin liner member to which an air-fuel mixture containing air and fuel is supplied, and a heating wire. The liner member disclosed in Japanese Patent No. 4807232 has a cylindrical sleeve shape. In the suction port structure disclosed in Japanese Patent No. 4807232, the liner member is inserted into a suction port of a cylinder head. In the suction port structure disclosed in Japanese Patent No. 4807232, the heating wire is spirally wound around the outer periphery of the liner member. In the suction port structure disclosed in Japanese Patent No. 4807232, the heating wire is fixed by being molded integrally with the liner member or coated (covered) with an insulating layer while being wound around the outer periphery of the liner member.

In the suction port structure disclosed in Japanese Patent No. 4807232, when the ambient temperature of the liner member decreases, the fuel of the air-fuel mixture supplied to the liner member may remain attached to the inner surface of the liner member. Therefore, in the suction port structure disclosed in Japanese Patent No. 4807232, the liner member is heated by the heating wire based on a decrease in the ambient temperature of the liner member. Thus, in the suction port structure disclosed in Japanese Patent No. 4807232, vaporization of the fuel attached to the inner surface of the liner member is promoted.

### PRIOR ART

### Patent Document

Patent Document 1: Japanese Patent No. 4807232

### SUMMARY OF THE INVENTION

### Problem to be Solved by the Invention

However, in the suction port structure disclosed in Japanese Patent No. 4807232, when the liner member is heated by the heating wire, disadvantageously, heat generated in the heating wire is not only transferred to the inner surface of the liner member, but also easily escapes to a member and a space outside the liner member. Therefore, in the suction port structure disclosed in Japanese Patent No. 4807232, the heat generated in the heating wire (heater) is not efficiently transferred to the fuel attached to the inner surface of the liner member, and thus the vaporization of the fuel cannot be efficiently promoted.

The present invention has been proposed in order to solve the aforementioned problem, and an object of the present invention is to provide an air intake apparatus of an internal combustion engine capable of efficiently transferring heat generated in a heater to fuel attached to the inner surface of the air intake apparatus to efficiently promote vaporization of the fuel.

### Means for Solving the Problem

In order to attain the aforementioned object, an air intake apparatus for an internal combustion engine according to a first aspect of the present invention includes an outer port member inserted into a suction port in a cylinder head, the outer port member facing an inner surface of the suction port, an inner port member arranged inside the outer port member, an intake passage formed inside the outer port member and the inner port member, the intake passage being configured to allow an air-fuel mixture containing air and fuel supplied to a cylinder to flow therethrough, and a heater arranged inside the inner port member. The inner port member is stacked on an outside of the heater in a direction orthogonal to an intake flow direction of the suction port, and is configured to insulate heat from the heater. The inner port member arranged inside the outer port member indicates a broader concept including a case in which at least a portion of the inner port member is arranged on the inner surface side of a central portion in a thickness from the inner surface to the outer surface of the outer port member.

In the air intake apparatus for an internal combustion engine according to the first aspect of the present invention, as described above, the inner port member is stacked on the outside of the heater in the direction orthogonal to the intake flow direction of the suction port, and is configured to insulate heat from the heater. Accordingly, at the time of heating of the heater, the inner port member significantly reduces or prevents transfer of heat generated in the heater to the inner port member, and thus escape of the heat of the heater to a portion other than a desired heated portion can be significantly reduced or prevented. Consequently, the heat generated in the heater can be easily and efficiently transferred to the fuel attached to the inner surface of the air intake apparatus, and thus the fuel can be efficiently vaporized. Furthermore, the heater is provided in the outer port member such that also in this respect, vaporization of the fuel attached to the inner surface of the air intake apparatus can be promoted. Thus, in the internal combustion engine, the air-fuel ratio in a combustion chamber can be stabilized, and thus the inside of the combustion chamber becomes an ideal combustion state such that unburned exhaust gas can be reduced.

The aforementioned air intake apparatus for an internal combustion engine according to the first aspect preferably further includes a heater protector configured to cover the heater from a side of the intake passage, and the heater protector preferably has a lower heat insulating property than that of the inner port member.

With this structure, heat from the heater is more easily transferred to the heater protector than to the inner port member, and thus the heat generated in the heater can be more easily and more efficiently transferred to the fuel attached to the inner surface of the air intake apparatus.

In this case, the heater protector, the heater, the inner port member, and the outer port member are preferably stacked in this order in the direction orthogonal to the intake flow direction of the suction port.

With this structure, in order to make it difficult to transfer heat radiated from the heater to the outer port member, the inner port member is arranged between the heater and the outer port member such that escape of the heat of the heater to the outer port member can be significantly reduced or prevented. Furthermore, the heater and the heater protector are directly stacked such that the heat from the heater can be more easily transferred to the heater protector than to the inner port member. Consequently, the heat generated in the heater can be more easily and more efficiently transferred to the fuel attached to the inner surface of the air intake apparatus.

In the aforementioned air intake apparatus for an internal combustion engine in which the heater protector, the heater, the inner port member, and the outer port member are stacked, the outer port member preferably includes a recess formed by recessing an inner surface thereof in the direction orthogonal to the intake flow direction of the suction port, and the heater protector, the heater, and the inner port member are preferably embedded in the recess of the outer port member while the heater protector, the heater, and the inner port member are stacked in this order in the direction orthogonal to the intake flow direction of the suction port.

With this structure, in order to prevent escape of the heat generated in the heater to a portion other than a desired heated portion, a heat transfer structure in which the heater protector, the heater, and the inner port member are stacked in the above order is embedded in the recess of the outer port member such that a decrease in the temperature of the heater due to intake air that flows through the intake passage can be significantly reduced or prevented. Furthermore, the heat transfer structure can be built in the outer port member, and thus an increase in the size of the heat transfer structure and the complexity of the heat transfer structure can be significantly reduced or prevented.

In the aforementioned air intake apparatus for an internal combustion engine according to the first aspect, each of the outer port member and the inner port member preferably includes an opening configured to allow fuel injected from an injector to be introduced therethrough, the injector supplying the fuel to the suction port.

With this structure, the fuel injected from the injector can be easily supplied to the intake passage inside the inner port member via the opening.

In this case, the heater preferably includes a planar heater provided along an inner surface of the inner port member, the planar heater having an open portion corresponding to a portion of the inner port member with the opening formed.

With this structure, the planar heater can be arranged along the inner surface of the inner port member, and thus the heat generated in the heater can be more efficiently transferred to the fuel attached to the inner surface of the air intake apparatus.

In the aforementioned air intake apparatus for an internal combustion engine according to the first aspect, a tip end of the outer port member is preferably inserted into the suction port up to at least a position at which fuel injected from an injector configured to supply the fuel to the suction port is introduced into the intake passage.

With this structure, the outer port member can be inserted up to a position on the downstream side of the suction port unlike a case in which the fuel injected from the injector is injected to the inner surface of the suction port downstream of the outer port member in the intake flow direction, and thus a range in which transfer of the heat of the cylinder head to the air in the suction port can be significantly reduced or prevented (the range of the outer port member covering the suction port) can be sufficiently increased. Consequently, a decrease in the density of the air supplied to the combustion chamber due to an increase in the temperature of the air in the suction port can be sufficiently significantly reduced or prevented, and thus the deterioration of the fuel efficiency due to the decrease in the density can be sufficiently significantly reduced or prevented.

An air intake apparatus for an internal combustion engine according to a second aspect of the present invention includes a port member inserted into a suction port in a cylinder head with an injector attached thereto, and an intake passage formed inside the port member, the intake passage being configured to allow an air-fuel mixture containing air and fuel supplied to a cylinder to flow therethrough. A tip end of the port member is inserted into the suction port up to at least a position at which fuel injected from an injector is introduced into the intake passage of the port member.

In the air intake apparatus for an internal combustion engine according to the second aspect of the present invention, as described above, the tip end of the port member is inserted into the suction port up to at least the position at which the fuel injected from the injector is introduced into the intake passage of the port member. Accordingly, the port member can be inserted up to a position on the downstream side of the suction port unlike a case in which the fuel injected from the injector is injected to the inner surface of the suction port downstream of the port member in the intake flow direction, and thus a range in which transfer of the heat of the cylinder head to the air in the suction port can be significantly reduced or prevented (the range of the port member covering the suction port) can be sufficiently increased. Consequently, a decrease in the density of the air supplied to a combustion chamber due to an increase in the temperature of the air in the suction port can be sufficiently significantly reduced or prevented, and thus the deterioration of the fuel efficiency due to the decrease in the density can be sufficiently significantly reduced or prevented.

In this case, the air intake apparatus for an internal combustion engine preferably further includes a heater provided in the port member, the heater being configured to vaporize the fuel introduced into the intake passage, and the tip end of the port member is preferably inserted up to a downstream end region of the suction port in an intake flow direction.

With this structure, the port member is inserted up to the downstream end region of the suction port such that the range in which transfer of the heat of the cylinder head to the air in the suction port can be significantly reduced or prevented can be further increased, and thus transfer of the heat of the cylinder head to the air in the suction port can be more sufficiently significantly reduced or prevented. Furthermore, the heater is provided in the port member such that the fuel introduced into the port member can be reliably vaporized. Thus, the vaporized fuel can be supplied into the combustion chamber while an increase in the temperature of the air in the suction port is more sufficiently significantly reduced or prevented, and thus combustion in the combustion chamber can be maintained in a good state while the deterioration of the fuel efficiency is more sufficiently significantly reduced or prevented. Furthermore, even during the cold start of the internal combustion engine or motoring of the internal combustion engine (when the temperature in the intake passage is low), for example, the fuel attached to the inner surface of the air intake apparatus for the internal combustion engine without being vaporized can be forcibly vaporized. Consequently, A/F (Air/Fuel ratio (air-fuel ratio)) during the cold start and motoring is stable, and the fuel injection amount can be controlled to be small. Thus, supply of an excessive amount of fuel into the combustion chamber can be significantly reduced or prevented.

In the aforementioned air intake apparatus for an internal combustion engine including the port member, the tip end of which is inserted up to the downstream end region in the intake flow direction of the suction port, the tip end of the port member is preferably inserted up to a position that overlaps an inlet opening configured to communicate a combustion chamber with the suction port in the intake flow direction of the suction port.

With this structure, the tip end of the port member is inserted up to the deepest portion of the suction port near the inlet opening, and thus the range in which transfer of the heat of the cylinder head to the air in the suction port can be significantly reduced or prevented can be further increased. Consequently, an increase in the temperature of the air in the suction port can be further significantly reduced or prevented, and thus the deterioration of the fuel efficiency due to a decrease in the density of the air supplied to the combustion chamber can be further significantly reduced or prevented.

In the air intake apparatus for an internal combustion engine including the port member, the tip end of which is inserted up to the position that overlaps the inlet opening, in a cross-section along the intake flow direction with the port member inserted into the suction port, a surface of the tip end of the port member on a side of the inlet opening is preferably inclined along an inclination direction of the inlet opening.

With this structure, the tip end of the port member has a shape that fits along the shape of the inner surface of the suction port near the inlet opening such that the port member can be inserted up to the vicinity of the boundary of the suction port with the inlet opening. Consequently, the heat of a portion of the cylinder head near the combustion chamber is less likely to be transferred to the air that flows through the intake passage, and thus an increase in the temperature of the air supplied to the combustion chamber can be effectively significantly reduced or prevented.

In the aforementioned air intake apparatus for an internal combustion engine including the port member, the tip end of which is inserted up to the position that overlaps the inlet opening, the tip end of the port member preferably includes a relief configured to prevent interference with an intake valve configured to open and close the inlet opening.

With this structure, the relief prevents interference between the port member and the intake valve, and thus the port member can be inserted up to the deepest portion of the suction port near the inlet opening. Consequently, the heat of the cylinder head can be made difficult to be transferred to the air that flows through the deepest portion near the inlet opening.

In the aforementioned air intake apparatus for an internal combustion engine according to the second aspect, the port member preferably includes an injector opening configured to allow the fuel injected from the injector to be introduced into the intake passage.

With this structure, the injector opening is simply formed in the port member such that fuel can be introduced into the intake passage, and thus the structure of the port member can be simplified.

In the aforementioned air intake apparatus for an internal combustion engine including the heater, the port member preferably includes an outer port member, and an inner port member having a heat insulating property, and the heater is preferably arranged inside the inner port member.

With this structure, at the time of heating of the heater, the inner port member significantly reduces or prevents transfer of heat generated in the heater to the inner port member, and thus escape of the heat of the heater to a portion other than a desired heated portion can be significantly reduced or prevented. Consequently, the heat generated in the heater can be easily and efficiently transferred to the fuel attached to the inner surface of the air intake apparatus, and thus the fuel can be efficiently vaporized.

In the air intake apparatus for an internal combustion engine according to the first and second aspects, the following structure is also conceivable.

(Appendix 1)

In the aforementioned air intake apparatus for an internal combustion engine according to the first and second aspects, an air layer as a heat insulating layer is formed between the outer surface of the outer port member and the inner surface of the suction port in a state in which the outer port member is inserted into the suction port.

With this structure, even when the temperature of the cylinder head increases and becomes high, heat transfer from the cylinder head to the outer port member can be significantly reduced or prevented, and thus an increase in the temperature of intake air in the intake passage can be significantly reduced or prevented.

(Appendix 2)

In the aforementioned air intake apparatus for an internal combustion engine in which the heater protector, the heater, the inner port member, and the outer port member are stacked, the inner port member stacked in order in the direction orthogonal to the intake flow direction of the suction port includes a foamed resin material, and the foamed resin material of the inner port member is arranged between the heater and the outer port member in the direction orthogonal to the intake flow direction of the suction port.

With this structure, the inner port member includes the foamed resin material such that the heat insulating property of the inner port member can be improved, and the weight of the inner port member can be reduced.

(Appendix 3)

In this case, the outer port member includes a non-foamed resin material.

With this structure, the foamed resin material having low heat resistance can be covered from the outside with the outer port member including the non-foamed resin material having higher heat resistance than that of the foamed resin material, and thus the heat resistance of the inner port member can be ensured.

(Appendix 4)

In the aforementioned air intake apparatus for an internal combustion engine according to the first and second aspects, the outer port member includes a flange that protrudes toward the center of a cross-sectional portion of the intake passage at the downstream end in the intake flow direction of the suction port, and the inner port member is covered with the flange from the opposite direction side in the intake flow direction of the suction portion.

With this structure, when high-temperature gas in the combustion chamber flows into the suction port, the inner port member is covered with the outer port member such that the high-temperature gas does not directly contact the inner port member, and thus the damage of the inner port member can be significantly reduced or prevented.

(Appendix 5)

In the aforementioned air intake apparatus for an internal combustion engine including the heater protector, the heater protector is a resin material or a resin film.

With this structure, the structure of the heater protector can be simplified.

(Appendix 6)

In the aforementioned air intake apparatus for an internal combustion engine according to the first and second aspects, the outer port member, the inner port member, and the heater have a U-shape or C-shape in which the injector side is open as viewed in the intake flow direction of the suction port.

With this structure, the fuel injected from the injector can be easily supplied to the intake passage, and the structure of the air intake apparatus for an internal combustion engine can be simplified.

(Appendix 7)

In the aforementioned air intake apparatus for an internal combustion engine including the port member including the relief, the relief includes an opening or a notch.

With this structure, interference with the intake valve can be prevented by a simple structure.

(Appendix 8)

In the aforementioned air intake apparatus for an internal combustion engine including the port member including the relief, a plurality of reliefs are provided to correspond to a plurality of intake valves in an internal combustion engine having the plurality of intake valves in each of a plurality of suction ports that supply an air-fuel mixture to a plurality of cylinders.

With this structure, even in the multi-cylinder internal combustion engine including the plurality of intake valves in each of the plurality of suction ports, the reliefs prevent interference between the port member and the intake valves, and thus the port member can be inserted up to the deepest portion of the suction port near the inlet opening.

### BRIEF DESCRIPTION OF THE DRAWINGS

FIG. 1 A sectional view showing an intake port attached to a cylinder head according to a first embodiment.

FIG. 2 A perspective view of the intake port according to the first embodiment.

FIG. 3 An exploded perspective view of the intake port according to the first embodiment.

FIG. 4 A sectional view of the intake port in a direction orthogonal to an intake flow direction according to the first embodiment.

FIG. 5 A schematic view showing a cross-section along a V-V line of FIG. 4, a temperature sensor, and a controller.

FIG. 6 A flowchart showing a heater heating treatment at the time of initial engine operation performed in the controller of the engine including the intake port according to the first embodiment.

FIG. 7 A flowchart showing a heater heating treatment at the time of engine restart performed in the controller of the engine including the intake port according to the first embodiment.

FIG. 8 A sectional view showing an intake port attached to a cylinder head according to a second embodiment.

FIG. 9 A perspective view of the intake port according to the second embodiment

FIG. 10 An exploded perspective view of the intake port according to the second embodiment.

FIG. 11 A sectional view showing the intake port inserted in a suction port according to the second embodiment.

FIG. 12 A schematic view showing a Z portion of FIG. 11 enlarged with an intake valve removed.

FIG. 13 A sectional view of the intake port in a direction orthogonal to an intake flow direction according to the second embodiment.

FIG. 14 A schematic view showing a cross-section along a XIV-XIV line of FIG. 13, a temperature sensor, and a controller.

FIG. 15 A sectional view corresponding to the V-V line of FIG. 4 and the XIV-XIV line of FIG. 13 according to a first modified example of the first and second embodiments.

FIG. 16 A sectional view corresponding to the V-V line of FIG. 4 and the XIV-XIV line of FIG. 13 according to a second modified example of the first and second embodiments.

### MODES FOR CARRYING OUT THE INVENTION

Embodiments of the present invention are hereinafter described on the basis of the drawings.

### First Embodiment

The structure of an engine E (an example of an “internal combustion engine” in the claims) is now described with reference to FIG. 1.

In the first embodiment, the upstream side and the downstream side are defined based on an airflow (hereinafter referred to as an intake flow direction A) that flows inside a suction port 11 and is suctioned into a combustion chamber 12. In a state in which the engine E having a plurality of cylinders 2 (only one cylinder is shown in FIG. 1) is mounted on a vehicle (not shown), a direction in which the cylinders 2 extend defined as a Z direction (upward-downward direction), one side in the Z direction is defined as a Zl direction (upward direction), and the other side in the Z direction is defined as a Z2 direction (downward direction). A direction in which the plurality of cylinders 2 are aligned is defined as an X direction (forward-rearward direction), one side in the X direction is defined as an X1 direction (forward direction), and the other in the X direction is defined as an X2 direction (rearward direction). A direction orthogonal to the Z direction and the X direction is defined as a Y direction (right-left direction), one side in the Y directions is defined as a Y1 direction (right direction), and the other in the Y directions is defined as a Y2 direction (left direction).

As shown in FIG. 1, the automobile engine E has a structure in which a cylinder head 1 is fixed to the Z1 direction side of a cylinder block (not shown). The cylinder head 1 includes a plurality of suction ports 11 and a plurality of exhaust ports 13 that communicate with combustion chambers 12. Furthermore, the cylinder head 1 includes intake valves 14 and exhaust valves 15 that open and close openings for communicating the combustion chambers 12 with the plurality of suction ports 11 and the plurality of exhaust ports 13.

A portion of each of the suction ports 11 near the opening that communicates the combustion chamber 12 with the suction port 11 extends in a direction (horizontal direction) along the Y2 direction. The suction port 11 may have a downward slope that is inclined in the Z2 direction toward the Y2 direction side over the entire region from the opening on the Y1 direction side to the opening that communicates the combustion chamber 12 with the suction port 11.

The engine E is configured to supply an air-fuel mixture M containing air K and fuel F into the combustion chamber 12 of the cylinder 2. Specifically, the engine E includes injectors 3 and an intake manifold 4.

The injectors 3 are configured to inject the atomized fuel F into the air K that flows toward the combustion chambers 12. Each of the injectors 3 is attached to the cylinder head 1 at an angle in the Z1 direction (upward direction) with respect to the intake flow direction A in the suction port 11. The injector 3 injects the fuel F so as to diffuse to the surroundings toward the combustion chamber 12. The fuel F is gasoline, gas fuel, or ethanol, for example. Thus, the engine E is a port-injection engine in which the fuel F is injected into the suction port 11.

The intake manifold 4 is configured to supply the air K into the combustion chamber 12.

Specifically, the intake manifold 4 is made of a resin. The intake manifold 4 includes a surge tank (not shown), an intake pipe 41, and a mount 42. The surge tank temporarily stores the air K. The surge tank is arranged at the upstream end of the intake manifold 4 in the intake flow direction A. The intake pipe 41 allows the air K to flow along a passage formed inside the intake pipe 41. The intake pipe 41 is arranged on the downstream side of the surge tank. The intake pipe 41 connects the surge tank to the mount 42. The mount 42 is provided such that a fastener (not shown) that fixes the intake manifold 4 to the cylinder head 1 is inserted thereinto. The mount 42 has a flange shape. The intake manifold 4 is fixed to the cylinder head 1 via the mount 42.

(Intake Port)

The engine E includes a resin intake port 5 (an example of an “air intake apparatus for an internal combustion engine” in the claims) that significantly reduces or prevents heat transfer from the cylinder head 1 to the air K supplied from the intake manifold 4 to the combustion chamber 12. Thus, the engine E has a heat insulating port structure in which the intake port 5 made of a resin is inserted into the suction ports 11 to insulate the heat from the cylinder head 1.

Specifically, as shown in FIGS. 1 to 3, the intake port 5 includes a mount 51, a plurality of (four) outer port members 52, a plurality of (four) inner port members 53, a plurality of (four) intake passages 54, a plurality of (four) heaters 55, and a plurality of (four) heater protection films 56 (an example of a “heater protector” in the claims).

The intake port 5 includes a flange including the mount 51 and a tubular portion including the outer port members 52, the inner port members 53, the intake passages 54, the heaters 55, and the heater protection films 56. In the intake port 5, the flange is a portion used to attach the intake port 5 to the cylinder head 1, and the tubular portion is a portion inserted into the suction port 11 from the upstream side of the suction port 11.

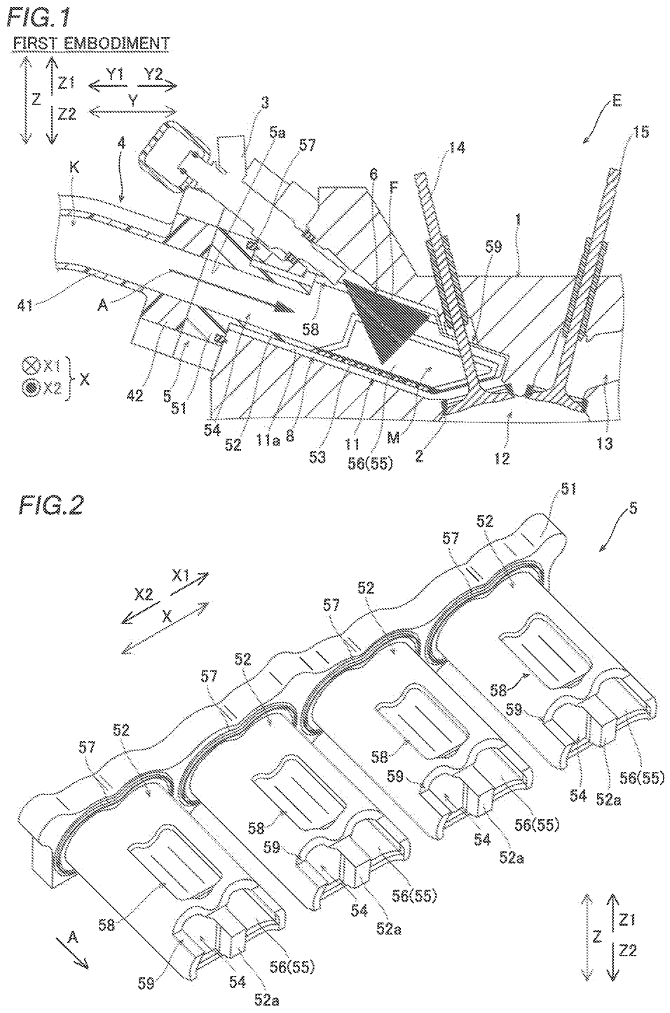

As shown in FIGS. 1 and 2, the intake port 5 is fixed to the cylinder head 1 together with the intake manifold 4 by the mount 51. The mount 51 of the intake port 5 is arranged between the mount 42 of the intake manifold 4 and a portion around a suction aperture of the suction port 11 of the cylinder head 1. The mount 51 has a flange shape. The mount 51 is configured to allow a fastener (not shown) that fixes the intake manifold 4 to the cylinder head 1 to be inserted thereto.

Gaskets 57 are arranged on the mount 51 of the intake port 5. The gaskets 57 are arranged on the suction port 11 side of the mount 51 of the intake port 5. The gaskets 57 are provided to significantly reduce or prevent entry of foreign matter such as water into the suction port 11 from between the mount 51 of the intake port 5 and the portion around the suction aperture of the suction port 11.

<Outer Port Member>

The outer port members 52 are now described. The shapes of the plurality of (four) outer port members 52 are the same as each other, and thus only the structure of the outer port member 52 arranged at the end on the X2 direction side is described. Similarly, only the inner port member 53, the intake passage 54, the heater 55, and the heater protection film 56 arranged at the end on the X2 direction side are described.

As shown in FIG. 1, the outer port member 52 has heat resistance to heat transmitted from the cylinder head 1 and heat from the combustion chamber 12. Specifically, the outer port member 52 has a non-foamed resin material. For example, the outer port member 52 is made of heat-resistant polyamide 6. Thus, in a range in which the outer port member 52 is arranged, a change in physical properties (melting, for example) with respect to the heat transmitted from the cylinder head 1 and the heat from the combustion chamber 12 can be significantly reduced or prevented.

The outer port member 52 is inserted into the suction port 11 of the cylinder head 1 and faces the inner surface 11a of the suction port 11. More specifically, the outer port member 52 has a length insertable from the upstream end of the suction port 11 to the vicinity of the downstream end of the suction port 11 in the intake flow direction A. That is, the outer port member 52 is arranged between the inner surface 11a of the suction port 11 and the intake passage 54 from the upstream end of the suction port 11 to the downstream end of the suction port 11. Thus, heat transfer from the cylinder head 1 to the air K that flows through the intake passage 54 can be significantly reduced or prevented from the upstream end of the suction port 11 to the downstream end of the suction port 11.

As shown in FIGS. 1 and 2, the outer port member 52 includes a partition wall 52a, an injector opening 58 (an example of an “opening” or an “injector opening” in the claims), and a valve opening 59 (an example of a “relief” in the claims).

The partition wall 52a has a function of dividing the air K that flows through the intake passage 54 according to the number of intake valves 14 provided for one suction port 11. That is, the partition wall 52a is configured to divide the air K that flows through the intake passage 54 into two sides when two intake valves 14 are provided for one suction port 11. Specifically, the partition wall 52a is provided on the downstream side of the outer port member 52. The partition wall 52a is arranged in a central portion in the X direction. The partition wall 52a is provided from a surface portion on the Z1 direction side (upward side) to a surface portion on the Z2 direction side (downward side) on the inner surface 52b of the outer port member 52.

The injector opening 58 is formed to introduce the fuel F injected from the injector 3 that supplies the fuel F to the suction port 11. That is, the injector opening 58 has an opening area larger than a fuel F injection region 6 of the injector 3. The injector opening 58 has a substantially rectangular shape as viewed from the Z1 direction side (upward side). The intake flow direction A is defined as the longitudinal direction of the injector opening 58.

The injector opening 58 is provided in a portion (upper portion) of the outer port member 52 on the Z1 direction side. The injector opening 58 is provided in a central portion in the X direction. The injector opening 58 is provided in the central portion in the intake flow direction A. The injector opening 58 passes through the outer port member 52 in a direction (Z direction) orthogonal to the intake flow direction A. The length of the injector opening 58 in the intake flow direction A is larger than a length from the upstream end of the partition wall 52a in the intake flow direction A to the central portion of the suction port 11 in the intake flow direction A. The length of the injector opening 58 in the X direction is smaller than the length of the outer port member 52 in the X direction when the outer port member 52 is viewed from the Z1 direction side (upward side).

The outer port member 52 has a C-shape as viewed from the downstream side in the intake flow direction A in a portion in which the injector opening 58 is formed.

The valve opening 59 is formed to prevent interference between the intake valve 14 and the outer port member 52. That is, the valve opening 59 has an opening area larger than an interference region between the intake valve 14 and the outer port member 52.

The valve opening 59 is provided in a portion (upper portion) of the outer port member 52 on the Z1 direction side. The valve opening 59 is provided at the downstream end in the intake flow direction A. The valve opening 59 is provided by removing a portion of the downstream end of the outer port member 52. The length of the valve opening 59 in the intake flow direction A is larger than the length of the partition wall 52a in the intake flow direction A.

The outer port member 52 has a C-shape as viewed from the downstream side in the intake flow direction A in a portion in which the valve opening 59 is formed.

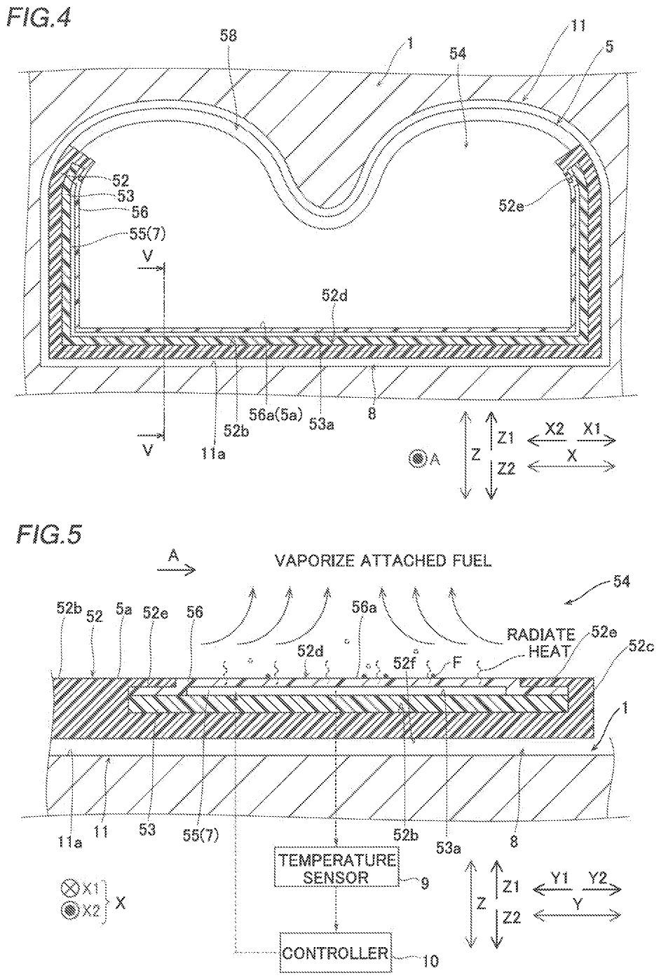

As shown in FIG. 4, the outer surface of such an outer port member 52 has a shape that matches the inner surface 11a of the suction port 11 in the cross-section orthogonal to the intake flow direction A. Furthermore, a distance between the outer surface of the outer port member 52 and the inner surface 11a of the suction port 11 is substantially constant.

<Inner Port Member>

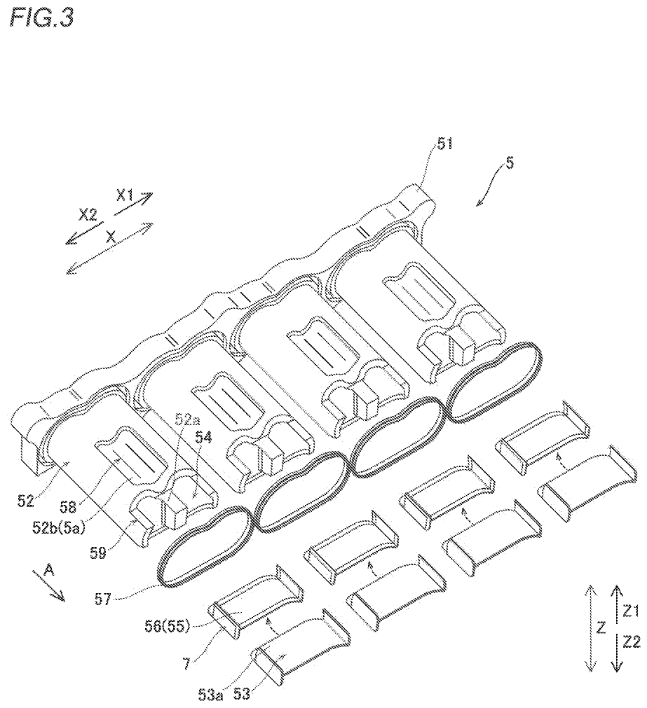

As shown in FIGS. 3 and 4, the inner port member 53 is configured to function as a heat insulation that significantly reduces or prevents heat transfer from the heater 55. Specifically, the inner port member 53 has a foamed resin material. That is, the inner port member 53 is formed by foam-molding polyamide. Thus, the inner port member 53 improves its heat insulating performance by forming bubbles in which gas is sealed. The inner port member 53 preferably has a heat transfer coefficient of about 10% or less of the heat transfer coefficient of the heater protection film 56.

The inner port member 53 is arranged inside the outer port member 52. Specifically, the inner port member 53 is embedded in the outer port member 52. The inner port member 53 is provided in direct contact with the inner surface 52b of the outer port member 52.

As shown in FIG. 1, the inner port member 53 is provided from the substantially central portion to the downstream end of the outer port member 52 in the intake flow direction A. That is, the arrangement position of the upstream end of the inner port member 53 in the intake flow direction A is between the position of the downstream end of the injector opening 58 of the outer port member 52 in the intake flow direction A and the position of the upstream end of the injector opening 58 of the outer port member 52 in the intake flow direction A.

The term “inner” indicates a range closer to the central portion of the intake passage 54 than the inner surface 11a of the suction port 11 in the cross-section of the suction port 11 orthogonal to the intake flow direction A. The term “outer” indicates a range closer to the inner surface 11a of the suction port 11 than the central portion of the intake passage 54 in the cross-section of the suction port 11 orthogonal to the intake flow direction A.

Thus, the inner port member 53 is provided inside the inner surface 52b of a portion of the outer port member 52.

As shown in FIGS. 1 and 3, the inner port member 53 includes an injector opening 58 and a valve opening 59. The injector opening 58 of the inner port member 53 has the same structure as that of the injector opening 58 of the outer port member 52, and thus description thereof is omitted. Furthermore, the valve opening 59 of the inner port member 53 has the same structure as that of the valve opening 59 of the outer port member 52, and thus description thereof is omitted.

The inner port member 53 has a C-shape as viewed from the downstream side in the intake flow direction A. That is, the inner port member 53 has a shape that matches the shape of the outer port member 52 as viewed from the downstream side in the intake flow direction A in a portion in which the valve opening 59 is formed.

Thus, both the outer port member 52 and the inner port member 53 include the injector openings 58 configured to allow the fuel F injected from the injector 3 that supplies the fuel F to the suction port 11 to be introduced therethrough. That is, the injector opening 58 of the outer port member 52 and the injector opening 58 of the inner port member 53 are provided such that the fuel F from the injector 3 can be injected (supplied) into the intake passage 54.

As described above, the intake port 5 has a two-divided structure in which the tubular portion (insertion member) inserted into the suction port 11 is divided into the outer port member 52 and the inner port member 53.

<Intake Passage>

The intake passage 54 is formed inside the outer port member 52 and the inner port member 53, and is configured to allow the air-fuel mixture M to flow therethrough. That is, the intake passage 54 is an internal space of the outer port member 52 and the inner port member 53. Specifically, the intake passage 54 passes through the outer port member 52 and the inner port member 53 in the intake flow direction A. The intake passage 54 has a flat shape in which the length in the Z direction is smaller than the length in the X direction as viewed from the downstream side in the intake flow direction A. That is, in the intake passage 54, the length in the X direction as viewed from the downstream side in the intake flow direction A is set according to the number of intake valves 14 provided for one suction port 11.

<Heater>

As shown in FIGS. 3 and 4, the heater 55 is configured to vaporize the fuel F attached to the inner surface 5a of the intake port 5 without being vaporized when the engine is cold immediately after the start of the engine (before warming of a three-way catalyst arranged in an exhaust pipe), for example. That is, the intake port 5 is configured to forcibly vaporize the fuel F attached to the inner surface 5a of the intake port 5 without being vaporized even when the ambient temperature is low. Thus, A/F (Air/Fuel ratio (air-fuel ratio)) at the time of cold start is stable, the fuel injection amount can be controlled to be small, and supply of the excessive amount of fuel F into the combustion chamber 12 can be significantly reduced or prevented.

Specifically, the heater 55 includes a heat generating element having high temperature rising characteristics. That is, the heater 55 preferably has high temperature rising characteristics to reach a predetermined temperature (about 70° C.) within a very short time (about 3 to about 5 seconds) from the initial engine operation. Therefore, the heater 55 has carbon graphite or carbon nanotubes, for example, as a heat generating element containing carbon as a main component. The heater 55 is preferably formed by attaching sheet-shaped carbon nanotubes to the heater protection film 56 or applying liquid carbon nanotubes to the heater protection film 56.

As shown in FIGS. 1 and 5, the heater 55 is arranged at a position at which heat can be directly applied to the fuel F attached to the inner surface 5a of the intake port 5 without being vaporized. Specifically, the heater 55 is arranged inside the inner port member 53. The heater 55 is arranged at a position corresponding to the injection region 6 of the injector 3. That is, the heater 55 is provided near the tip end of the outer port member 52. Specifically, the heater 55 is built in a range from the central portion to the downstream end of the outer port member 52 in the intake flow direction A.

The heater 55 is configured to reliably apply heat to the fuel F that diffuses and adheres to the inner surface 5a of the intake port 5. Specifically, the heater 55 is provided over substantially the entire inner surface 53a of the inner port member 53 in the cross-section orthogonal to the intake flow direction A. That is, the heater 55 includes a planar heater 7 provided along the inner surface 53a of the inner port member 53 and having an open portion in which the injector opening 58 is formed.

<Heater Protection Film>

As shown in FIGS. 4 and 5, the heater protection film 56 is configured to protect the heater 55 such that the fuel F injected from the injector 3 is not attached to the heater 55. Specifically, the heater protection film 56 covers the heater 55 from the intake passage 54 side. That is, the heater protection film 56 is provided over the entire cross-sectional shape of the heater 55 orthogonal to the intake flow direction A. Thus, the heater protection film 56 is provided along the inner surface of the heater 55, and the portion in which the injector opening 58 is formed is open.

The heater protection film 56 is made of a material that easily fits along the inner surface of the heater 55. Specifically, the heater protection film 56 is a resin film. The heater protection film 56 is preferably made of a resin material having heat resistance, oil resistance, and chemical resistance. For example, as the heater protection film 56, polyimide is preferably used, for example.

The heater protection film 56 is configured to easily transfer heat from the heater 55. Specifically, the heater protection film 56 is a thin resin film so as not to interfere with heat radiation from the heater 55 toward the intake passage 54. That is, the heater protection film 56 is preferably a thin resin film having a thickness of about 0.125 mm, for example.

The heater protection film 56 has a lower heat insulating property than that of the inner port member 53. Specifically, the heat transfer coefficient of the heater protection film 56 is preferably about ten times or more the heat transfer coefficient of the inner port member 53.

<Internal Structure of Intake Port>

As shown in FIGS. 4 and 5, in the internal structure of the intake port 5 according to the first embodiment, heat radiated from the heater 55 does not escape to a portion other than the inner surface of the heater 55 on the intake passage 54 side. The internal structure of the intake port 5 indicates the structure (see FIG. 4) of a cross-section orthogonal to the intake flow direction A in a portion of the intake port 5 in which the inner port member 53 and the heater 55 are provided. Furthermore, the internal structure of the intake port 5 indicates the structure (see FIG. 5) of a cross-section along the intake flow direction A in the position of the intake port 5 in which the inner port member 53 and the heater 55 are provided.

Specifically, the inner port member 53 is stacked on the heater 55 in the direction orthogonal to the intake flow direction A of the suction port 11, and is configured to insulate heat from the heater 55. That is, the inner surface 53a of the inner port member 53 on the intake passage 54 side is in surface contact with the outer surface of the heater 55 on the side opposite to the intake passage 54 side. As described above, the inner port member 53 has a material that insulates heat from the heater 55. Thus, the foamed resin material of the inner port member 53 is arranged between the heater 55 and the outer port member 52 in the direction orthogonal to the intake flow direction A.

The internal structure of the intake port 5 is four-layered. Specifically, the heater protection film 56, the heater 55, the inner port member 53, and the outer port member 52 are stacked in this order in the direction orthogonal to the intake flow direction A. That is, in the intake port 5, a stacked structure including the heater protection film 56, the heater 55, the inner port member 53, and the outer port member 52 is formed in a portion of the outer port member 52.

The outer surface of the heater protection film 56 on the side opposite to the intake passage 54 side is in surface contact with the inner surface of the heater 55 on the intake passage 54 side. As described above, the heater 55 and the inner port member 53 are in surface contact with each other. The outer surface of the inner port member 53 on the side opposite to the intake passage 54 side is in surface contact with the inner surface 52b of the outer port member 52 on the intake passage 54 side.

The outer port member 52 includes an embedded recess 52d (an example of a “recess” in the claims) formed by recessing the inner surface 52b in the direction orthogonal to the intake flow direction A. The embedded recess 52d is formed over substantially the entire inner surface 52b of the outer port member 52 in the cross-section orthogonal to the intake flow direction A. The stacked structure including the heater protection film 56, the heater 55, the inner port member 53, and the outer port member 52 is embedded in the embedded recess 52d.

Specifically, the heater protection film 56, the heater 55, and the inner port member 53 are embedded in the embedded recess 52d of the outer port member 52 in a state in which the heater protection film 56, the heater 55, and the inner port member 53 are stacked in this order in the direction orthogonal to the intake flow direction A of the suction port 11. That is, in the intake port 5, a heat transfer structure that does not allow heat radiated from the heater 55 to escape to a portion other than a desired heated portion is built in the outer port member 52.

The outer port member 52 is configured to wrap around the peripheral edge of the inner port member 53. That is, the outer port member 52 is configured to thermally protect the inner port member 53 by having higher heat resistance than that of the inner port member 53.

Specifically, the outer port member 52 includes a flange 52c that protrudes toward the center of the cross-sectional portion of the intake passage 54 at the downstream end in the intake flow direction A. That is, the inner port member 53 is covered with the flange 52c from the opposite direction side in the intake flow direction A. The flange 52c forms an end of the embedded recess 52d in the intake flow direction A. Thus, the flange 52c of the outer port member 52 thermally shields the inner port member 53 from high heat radiated from the combustion chamber 12 (see FIG. 1).

The outer port member 52 is configured to significantly reduce or prevent peeling of the heater protection film 56 provided with the heater 55 from the inner port member 53. Specifically, the outer port member 52 includes a protruding pressing portion 52e that presses the heater protection film 56 provided with the heater 55 in the direction orthogonal to the intake flow direction A. The protruding pressing portion 52e presses the peripheral edge of a surface of the heater protection film 56 provided with the heater 55 on the intake passage 54 side. That is, in the cross-section of the embedded recess 52d in the intake flow direction A shown in FIG. 5, the protruding pressing portion 52e protrudes from the peripheral edge of the embedded recess 52d on the intake flow direction A side toward the center of the embedded recess 52d.

In the internal structure of the intake port 5, the inner surface 56a of the heater protection film 56 and the inner surface 52b of the outer port member 52 are substantially flush with each other. Specifically, the heater protection film 56 and the inner surface 52b of the outer port member 52 adjacent to the portion in which the inner port member 53 is provided on the intake passage 54 side are flush with each other.

The outer port member 52, the inner port member 53, and the heater 55 have a substantially C-shape (substantially U-shape) in which the injector 3 side is open as viewed in the intake flow direction A of the suction port 11. That is, the outer port member 52, the inner port member 53, and the heater 55 have a shape in which a portion is omitted due to the injector opening 58 provided according to the position of the injector 3.

As shown in FIGS. 1 and 4, the intake port 5 is configured to insulate heat from the cylinder head 1. Specifically, in a state in which the outer port member 52 is inserted into the suction port 11, an air layer 8 as a heat insulating layer is formed between the outer surface 52f of the outer port member 52 and the inner surface 11a of the suction port 11. That is, the air layer 8 is formed, and thus in the direction orthogonal to the intake flow direction A, the cross-sectional shape of the outer port member 52 is smaller than the cross-sectional shape of the suction port 11.

In the intake port 5 including the structure described above, the outer port member 52 and a joining member that fixes the heater protection film 56 with the heater 55 to the inner port member 53 are integrally formed. That is, the intake port 5 is formed by insert-molding the joining member into the outer port member 52.

(ECU)

As shown in FIG. 5, the engine E includes a temperature sensor 9 that measures the temperature of the heater 55, and a controller 10 that controls the temperature of the heater 55 based on the temperature measured by the temperature sensor 9.

The controller 10 includes an engine control unit (ECU) including a central processing unit (CPU) (not shown) as a control circuit and a memory (not shown) as a storage medium.

The controller 10 controls each portion of the engine E by executing an engine control program stored in the memory with the CPU. Furthermore, the controller 10 is configured to grasp information such as a first predetermined condition, a second predetermined condition, and the temperature of the heater 55.

The first predetermined condition is a condition for preheating the heater 55 before the engine is initially started, and is a condition including at least one of a user approaching a vehicle with a wireless key, the user unlocking a door, the user sitting on a seat, or the user depressing a brake pedal, for example. The second predetermined condition is a condition for preheating the heater 55 before the engine is restarted, and is a condition including at least one of the outside air temperature, the temperature of the three-way catalyst arranged in the exhaust pipe, the temperature of the inner wall surface of the suction port 11, or the temperature of cooling water of the engine E, for example.

The controller 10 is configured to prevent excessive heat generation of the heater 55 based on the temperature measured by the temperature sensor 9 by the engine control program. Furthermore, the controller 10 is configured to control the heater 55 to reliably vaporize the fuel F attached to the inner surface 5a of the intake port 5 without being vaporized based on the first predetermined condition and the second predetermined condition by the engine control program.

An optimum sensor as the temperature sensor 9 is selected from a thermistor, a thermocouple, and a side temperature resistor, for example. As the temperature sensor 9, a sensor having a quick response to a temperature change is preferably used.

(Heater Heating Treatment at Time of Initial Engine Operation)

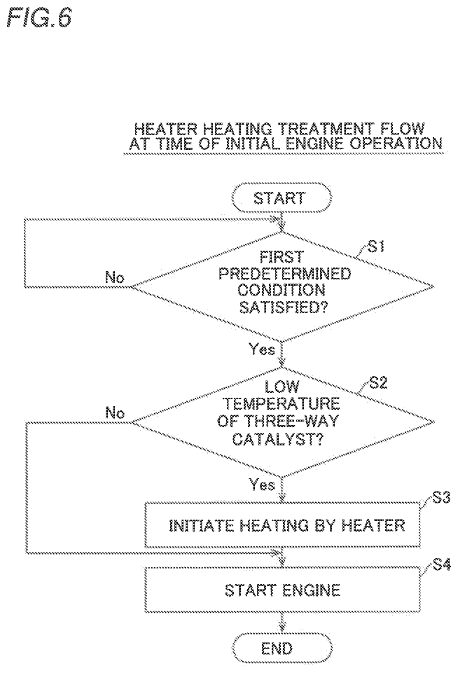

A heater heating treatment at the time of the initial engine operation included in an engine control process by the controller 10 is described below with reference to FIG. 6. The heater heating treatment at the time of the initial engine operation is to initiate heating of the heater 55 in advance before the initial engine operation.

In step S1, the controller 10 determines whether or not the first predetermined condition (the user unlocking the door, for example) is satisfied. The controller 10 advances to step S2 when the first predetermined condition is satisfied, and returns to step S1 when the first predetermined condition is not satisfied. In step S2, the controller 10 determines whether or not the temperature of the three-way catalyst is lower than a predetermined temperature. The controller 10 advances to step S3 when the temperature of the three-way catalyst is lower, and advances to step S4 when the temperature of the three-way catalyst is not lower (when the temperature is higher) and starts the engine. Then, the heater heating treatment at the time of the initial engine operation is terminated.

After initiating heating by the heater 55 in step S3, the controller 10 advances to step S4 and starts the engine E. Then, after advancing to step S4, the controller 10 terminates the heater heating treatment at the time of the initial engine operation.

The controller 10 stops the heating of the heater 55 when terminating the heater heating treatment at the time of the initial engine operation. The heating of the heater 55 may be stopped when warming of the three-way catalyst is completed, or after a predetermined time (about 20 to about 30 seconds) has elapsed after the engine is started, for example.

(Heater Heating Treatment at Time of Engine Restart)

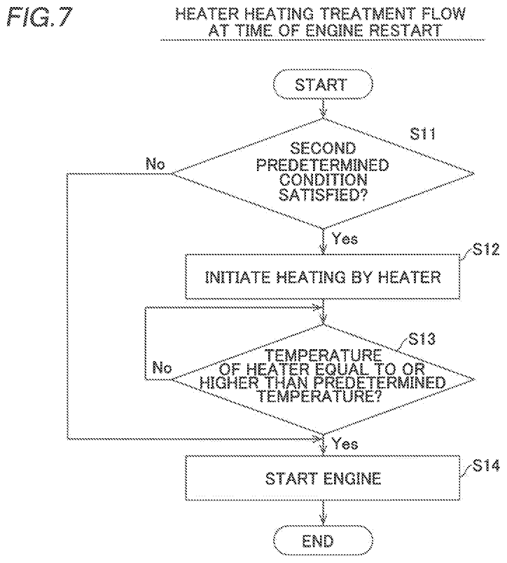

The heater heating treatment at the time of engine restart included in the engine control process by the controller 10 is described below with reference to FIG. 7. The heater heating treatment at the time of the engine restart is to initiate heating of the heater 55 in advance before the engine restart.

In step S11, the controller 10 determines whether or not the second predetermined condition (the temperature of the three-way catalyst is lower, for example) is satisfied. The controller 10 advances to step S12 when the second predetermined condition is satisfied, and advances to step S14 when the second predetermined condition is not satisfied and starts the engine. Then, the heater heating treatment at the time of the engine restart is terminated.

In step S12, the controller 10 initiates heating by the heater 55. In step S13, the controller 10 determines whether or not the temperature of the heater 55 is equal to or higher than a predetermined temperature. The controller 10 advances to step S14 when the temperature of the heater 55 is equal to or higher than the predetermined temperature, and returns to step S13 when the temperature of the heater 55 is lower than the predetermined temperature.

After starting the engine E in step S14, the controller 10 terminates the heater heating treatment at the time of the engine restart.

The controller 10 stops the heating of the heater 55 when terminating the heater heating treatment at the time of the engine restart. The heating of the heater 55 may be stopped when warming of the three-way catalyst is completed, or after a predetermined time (about 20 to about 30 seconds) has elapsed after the engine restart, for example.

### Advantageous Effects of First Embodiment

According to the first embodiment, the following advantageous effects are achieved.

According to the first embodiment, as described above, the inner port member 53 is stacked on the outside of the heater 55 in the direction orthogonal to the intake flow direction A of the suction port 11, and is configured to insulate heat from the heater 55. Accordingly, at the time of heating of the heater 55, the inner port member 53 significantly reduces or prevents transfer of heat generated in the heater 55 to the inner port member 53, and thus escape of the heat of the heater 55 to a portion other than a desired heated portion can be significantly reduced or prevented. Consequently, the heat generated in the heater 55 can be easily and efficiently transferred to the fuel F attached to the inner surface 5a of the intake port 5, and thus the fuel F can be efficiently vaporized.

According to the first embodiment, as described above, the heater 55 is provided in the outer port member 52. Accordingly, also in this respect, vaporization of the fuel F attached to the inner surface 5a of the intake port 5 can be promoted. Thus, in the engine E, the air-fuel ratio in the combustion chamber 12 can be stabilized, and thus the inside of the combustion chamber 12 becomes an ideal combustion state such that unburned exhaust gas can be reduced.

According to the first embodiment, as described above, the heater protection film 56 is provided to cover the heater 55 from the intake passage 54 side. The heater protection film 56 has a lower heat insulating property than that of the inner port member 53. Accordingly, heat from the heater 55 is more easily transferred to the heater protection film 56 than to the inner port member 53, and thus the heat generated in the heater 55 can be more easily and more efficiently transferred to the fuel F attached to the inner surface 5a of the intake port 5.

According to the first embodiment, as described above, the heater protection film 56, the heater 55, the inner port member 53, and the outer port member 52 are stacked in this order in the direction orthogonal to the intake flow direction A of the suction port 11. Accordingly, in order to make it difficult to transfer heat radiated from the heater 55 to the outer port member 52, the inner port member 53 is arranged between the heater 55 and the outer port member 52 such that escape of the heat of the heater 55 to the outer port member 52 can be significantly reduced or prevented. Furthermore, the heater 55 and the heater protection film 56 are directly stacked such that the heat from the heater 55 can be more easily transferred to the heater protection film 56 than to the inner port member 53. Consequently, the heat generated in the heater 55 can be more easily and more efficiently transferred to the fuel F attached to the inner surface 5a of the intake port 5.

According to the first embodiment, as described above, the outer port member 52 includes the embedded recess 52d formed by recessing the inner surface 52b in the direction orthogonal to the intake flow direction A of the suction port 11. The heater protection film 56, the heater 55, and the inner port member 53 are embedded in the embedded recess 52d of the outer port member 52 while the heater protection film 56, the heater 55, and the inner port member 53 are stacked in this order in the direction orthogonal to the intake flow direction A of the suction port 11. Accordingly, in order to prevent escape of the heat generated in the heater 55 to a portion other than a desired heated portion, the heat transfer structure in which the heater protection film 56, the heater 55, and the inner port member 53 are stacked in the above order is embedded in the embedded recess 52d of the outer port member 52 such that a decrease in the temperature of the heater 55 due to intake air that flows through the intake passage 54 can be significantly reduced or prevented. Furthermore, the heat transfer structure can be built in the outer port member 52, and thus an increase in the size of the heat transfer structure and the complexity of the heat transfer structure can be significantly reduced or prevented.

According to the first embodiment, as described above, each of the outer port member 52 and the inner port member 53 includes the injector opening 58 configured to allow the fuel F injected from the injector 3 that supplies the fuel F to the suction port 11 to be introduced therethrough. Accordingly, the fuel F injected from the injector 3 into the inner port member 53 via the injector opening 58 can be easily supplied to the intake passage 54.

According to the first embodiment, as described above, the heater 55 is provided on the planar heater 7 provided along the inner surface 53a of the inner port member 53 and having the open portion corresponding to the portion of the inner port member 53 in which the injector opening 58 is formed. Accordingly, the planar heater 7 can be arranged along the inner surface 53a of the inner port member 53, and thus the heat generated in the heater 55 can be more efficiently transferred to the fuel F attached to the inner surface 5a of the intake port 5.

According to the first embodiment, as described above, the air layer 8 as a heat insulating layer is formed between the outer surface 52f of the outer port member 52 and the inner surface 11a of the suction port 11 in a state in which the outer port member 52 is inserted into the suction port 11. Accordingly, even when the temperature of the cylinder head 1 increases and becomes high, heat transfer from the cylinder head 1 to the outer port member 52 can be significantly reduced or prevented, and thus an increase in the temperature of intake air in the intake passage 54 can be significantly reduced or prevented.

According to the first embodiment, as described above, the inner port member 53 stacked in order in the direction orthogonal to the intake flow direction A of the suction port 11 includes the foamed resin material. The foamed resin material of the inner port member 53 is arranged between the heater 55 and the outer port member 52 in the direction orthogonal to the intake flow direction A of the suction port 11. Accordingly, the inner port member 53 includes the foamed resin material such that the heat insulating property of the inner port member 53 can be improved, and the weight of the inner port member 53 can be reduced.

According to the first embodiment, as described above, the outer port member 52 includes the non-foamed resin material. Accordingly, the foamed resin material having low heat resistance can be covered from the outside with the outer port member 52 including the non-foamed resin material having higher heat resistance than that of the foamed resin material, and thus the heat resistance of the inner port member 53 can be ensured.

According to the first embodiment, as described above, the outer port member 52 includes the flange 52c that protrudes toward the center of the cross-sectional portion of the intake passage 54 at the downstream end in the intake flow direction A of the suction port 11. The inner port member 53 is covered with the flange 52c from the opposite direction side in the intake flow direction A of the suction portion 11. Accordingly, when high-temperature gas in the combustion chamber 12 flows into the suction port 11, the inner port member 53 is covered with the outer port member 52 such that the high-temperature gas does not directly contact the inner port member 53, and thus the damage of the inner port member 53 can be significantly reduced or prevented.

According to the first embodiment, as described above, the heater protection film 56 is a resin film. Accordingly, the structure of the heater protection film 56 can be simplified.

According to the first embodiment, as described above, the outer port member 52, the inner port member 53, and the heater 55 have a C-shape (U-shape) in which the injector 3 side is open as viewed in the intake flow direction A of the suction port 11. Accordingly, the fuel F injected from the injector 3 can be easily supplied to the intake passage 54, and the structure of the intake port 5 can be simplified.

According to the first embodiment, the heater 55 is provided near the tip end of the outer port member 52. Accordingly, the heater 55 is arranged at a position on the inner surface 5a of the intake port 5 to which the fuel F injected from the injector 3 is easily attached such that vaporization of the fuel F attached to the inner surface 5a of the intake port 5 can be further promoted. Consequently, in the engine E, the air-fuel ratio in the combustion chamber 12 can be further stabilized, and thus the inside of the combustion chamber 12 becomes an ideal combustion state such that unburned exhaust gas can be further reduced.

According to the first embodiment, as described above, the outer port member 52 includes the protruding pressing portion 52e that presses the heater protection film 56 provided with the heater 55 in the direction orthogonal to the intake flow direction A. Accordingly, peeling of the heater protection film 56 can be significantly reduced or prevented, and thus application of the fuel F to the heater 55 due to exposure of the heater 55 to the intake passage 54 can be significantly reduced or prevented. Consequently, the damage to the heater 55 can be significantly reduced or prevented.

According to the first embodiment, as described above, the portion of the suction port 11 near the opening that communicates the combustion chamber 12 with the suction port 11 extends in the direction along the Y2 direction (horizontal direction) without being inclined in the Z1 direction toward the Y2 direction side to have a rising slope. Accordingly, the fuel F, water, oil, etc. that have entered the air layer 8 formed between the outer surface 52f of the outer port member 52 and the inner surface 11a of the suction port 11 can be easily discharged to the combustion chamber 12, and thus accumulation of the fuel F, water, oil, etc. on the inner surface 11a of the suction port 11 can be significantly reduced or prevented.

### Second Embodiment

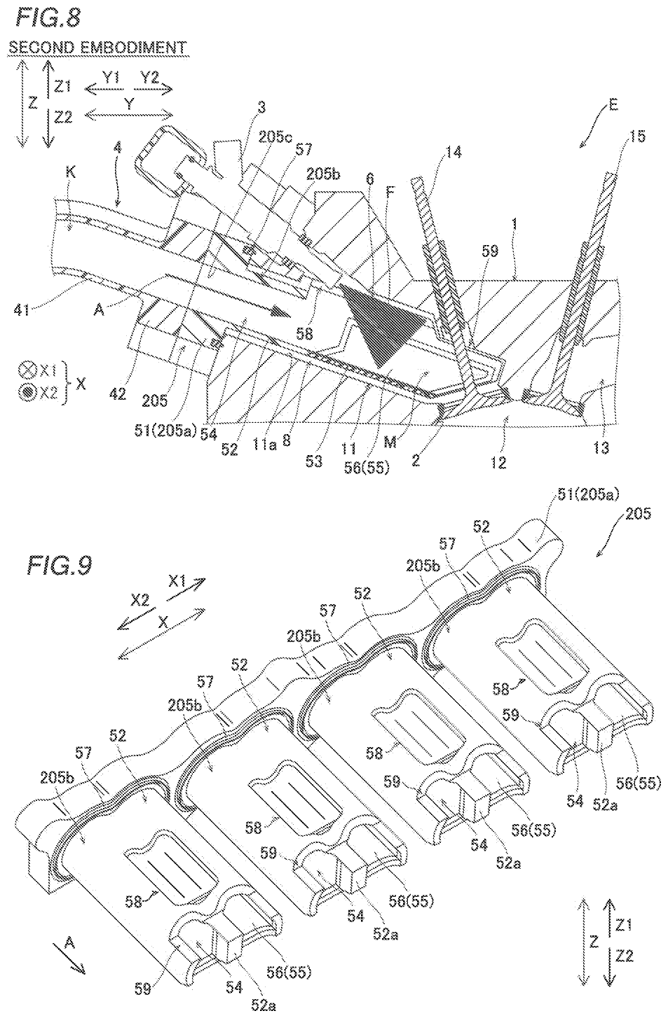

The structure of an intake port 205 according to a second embodiment of the present invention is now described with reference to FIGS. 8 to 14. In the first embodiment, the intake port 5 including the outer port member 52 having a length insertable from the upstream end of the suction port 11 to the vicinity of the downstream end of the suction port 11 is described in more detail, and in the second embodiment, an intake port 205 including a port member 205b inserted into a suction port 11 up to the boundary between the suction port 11 and an inlet opening 12a is described. In the second embodiment, the same or similar structures as those of the first embodiment are denoted by the same reference numerals as those of the first embodiment, and description thereof is omitted.

As shown in FIG. 8, an automobile engine E (an example of an “internal combustion engine” in the claims) has a structure in which a cylinder head 1 is fixed to the Z1 direction side of a cylinder block (not shown).

(Intake Port)

The engine E includes the resin intake port 205 (an example of an “air intake apparatus for an internal combustion engine” in the claims) that significantly reduces or prevents heat transfer from the cylinder head 1 to air K supplied from an intake manifold 4 to combustion chambers 12. Thus, the engine E has a heat insulating port structure in which the intake port 205 made of a resin is inserted into the suction ports 11 to insulate the heat from the cylinder head 1.

Specifically, as shown in FIGS. 8 to 10, the intake port 205 according to the second embodiment includes a mount 51, a plurality of (four) outer port members 52, a plurality of (four) inner port members 53, a plurality of (four) intake passages 54, a plurality of (four) heaters 55, and a plurality of (four) heater protection films 56 (an example of a “heater protector” in the claims).

The intake port 205 includes a flange member 205a including the mount 51, and port members 205b including the outer port members 52, the inner port members 53, the intake passages 54, the heaters 55, and the heater protection films 56. Furthermore, in the intake port 205, the flange member 205a is a portion used to attach the intake port 205 to the cylinder head 1, and the port members 205b are portions inserted into the suction ports 11 from the upstream side of the suction ports 11.

As shown in FIGS. 8 and 9, the intake port 205 is fixed to the cylinder head 1 together with the intake manifold 4 by the mount 51.

<Port Member>

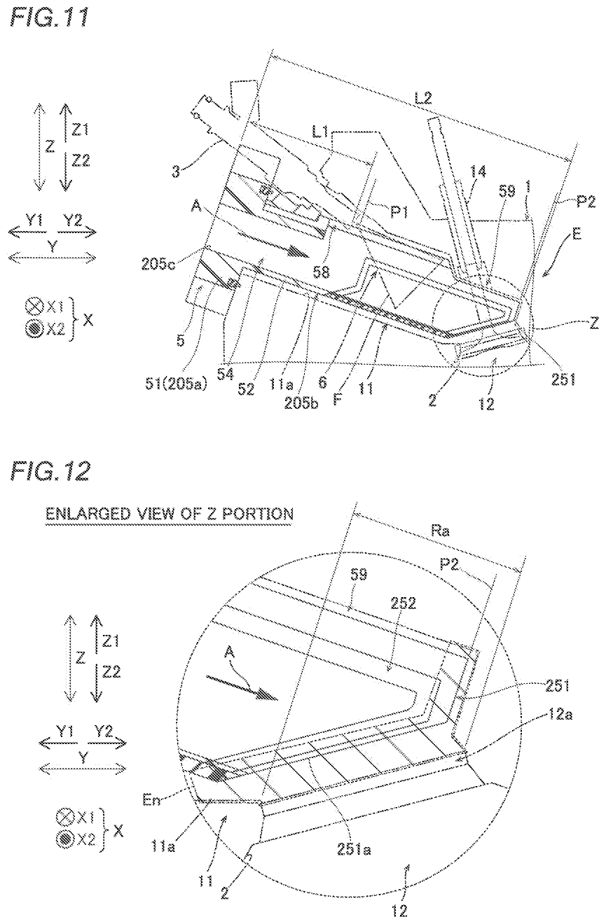

As shown in FIG. 11, the tip end 251 (the tip end 251 of the outer port member 52) of each of the port members 205b according to the second embodiment is inserted into the suction port 11 up to at least a position P1 at which the fuel F injected from each injector 3 is introduced into the intake passage 54 of the port member 205b. That is, the port member 205b is configured such that the fuel F is injected from the injector 3 toward the inner surface 205c.

Specifically, in an intake flow direction A, the length of the port member 205b is larger than at least a first predetermined length L1 from the upstream end of the suction port 11 to a position corresponding to the tip end of the injector 3. That is, in the intake flow direction A, the position P1 at which the fuel F is introduced from the injector 3 in the port member 205b is located closer to the combustion chamber 12 than a tip end position of the first predetermined length L1 in the suction port 11.

The port member 205b extends along the intake flow direction A to a range in the suction port 11 through which an intake valve 14 passes (a position that interferes with the intake valve 14) when the intake valve 14 is opened and closed. Specifically, in the intake flow direction A, the length of the port member 205b is larger than the first predetermined length L1 and smaller than the second predetermined length L2 from the upstream end to the downstream end of the suction port 11.

That is, as shown in FIG. 12, the port member 205b is inserted into the suction port 11 up to a boundary between the suction port 11 and the inlet opening 12a. Specifically, the tip end 251 of the port member 205b is inserted up to a downstream end region En of the suction port 11 in the intake flow direction A. That is, the port member 205b is provided in substantially the entire region of the suction port 11 in the intake flow direction A.

The port member 205b includes a protrusion 252 that overlaps the inlet opening 12a as viewed in a direction orthogonal to the intake flow direction A. That is, the tip end 251 of the port member 205b is inserted up to a position P2 that overlaps the inlet opening 12a in the intake flow direction A of the suction port 11. The protrusion 252 of the port member 205b protrudes within a predetermined range Ra from the upstream end to the downstream end of the inlet opening 12a in the intake flow direction A.

The port member 205b has a shape that matches the shape of the inner surface 11a of the suction port 11. Specifically, in the cross-section along the intake flow direction A with the port member 205b inserted into the suction port 11, the protrusion 252 of the port member 205b has a substantially trapezoidal shape, and a main portion of the port member 205b other than the protrusion 252 has a rectangular shape. In the cross-section along the intake flow direction A with the port member 205b inserted into the suction port 11, a surface 251a of the tip end 251 of the port member 205b on the inlet opening 12a side is inclined along the inclination direction of the inlet opening 12a. The inclination direction refers to a direction in which the inlet opening 12a is inclined in a Z1 direction toward the Y2 direction side.

As shown in FIG. 11, the port member 205b is inserted into the suction port 11 in the cylinder head 1 to which the injectors 3 are attached. The port member 205b is configured to cover at least a portion (a portion on the Z2 direction side) of the cylinder head 1 on the combustion chamber 12 side in a Z direction. That is, the port member 205b is configured to cover at least a portion of the inner surface 11a of the suction port 11 on the Z2 direction side with respect to the central portion in the Z direction.

<Outer Port Member>

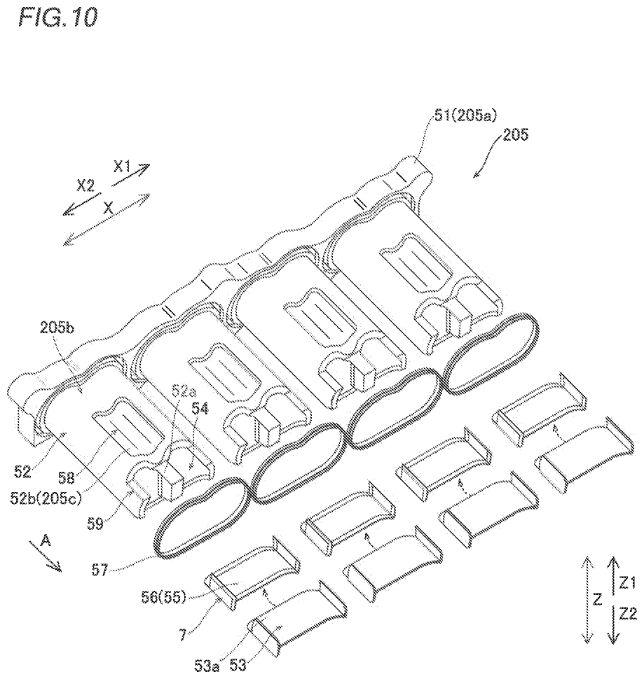

The outer port members 52 are now described. As shown in FIGS. 9 and 10, the shapes of the plurality of (four) outer port members 52 are the same as each other, and thus only the structure of the outer port member 52 arranged at the end on the X2 direction side is described. Similarly, only the inner port member 53, the intake passage 54, the heater 55, and the heater protection film 56 arranged at the end on the X2 direction side are described.

As shown in FIGS. 8 and 9, the outer port member 52 includes a partition wall 52a, an injector opening 58 (an example of an “opening” or an “injector opening” in the claims), and a valve opening 59 (an example of a “relief” in the claims).

The outer port member 52 has a C-shape as viewed from the downstream side in the intake flow direction A in a portion in which the injector opening 58 is formed. That is, the portion of the port member 205b in which the injector opening 58 is formed has a C-shape (U-shape) in which the injector 3 side is open in the cross-section in the direction orthogonal to the intake flow direction A of the suction port 11.

The valve opening 59 is provided by removing a portion of the downstream end of the outer port member 52. That is, the valve opening 59 includes a notch that is open in the Z1 direction and in a direction along the intake flow direction A.

A plurality of (two) such valve openings 59 are provided to correspond to a plurality of (two) intake valves 14 in the engine E including the plurality of (two) intake valves 14 for each of the plurality of (four) suction ports 11 for supplying an air-fuel mixture M to a plurality of (four) cylinders 2, respectively. The structure of the outer port member 52 is the same as that of the first embodiment, and thus description thereof is omitted.

<Inner Port Member>

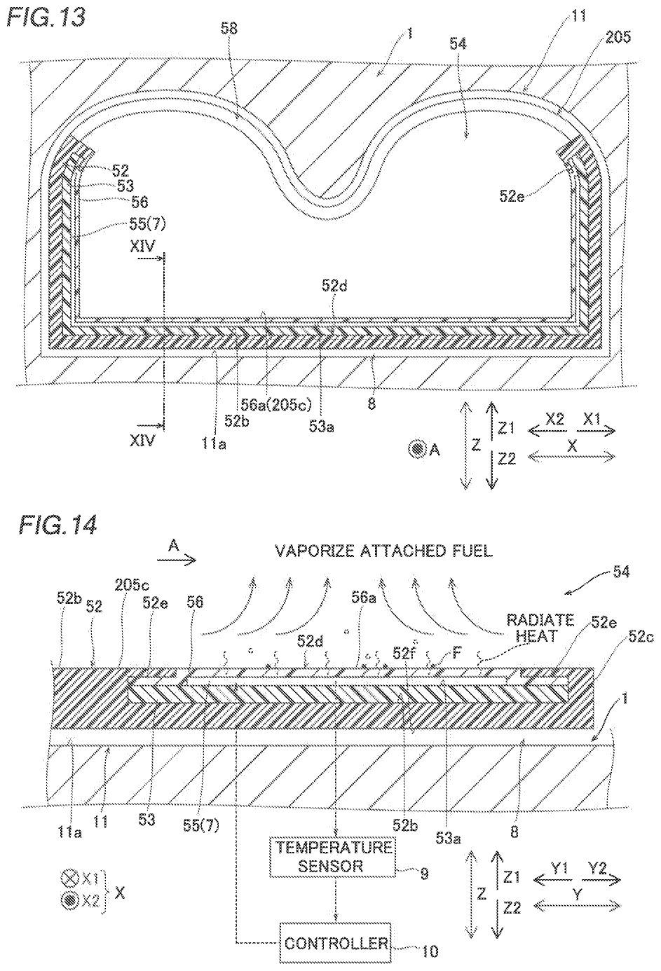

As shown in FIGS. 13 and 14, the inner port member 53 is configured to function as a heat insulation that significantly reduces or prevents heat transfer from the heater 55. The structure of the inner port member 53 is the same as that of the first embodiment, and thus description thereof is omitted.

<Heater>

The heater 55 is configured to vaporize the fuel F attached to the inner surface 205c of the intake port 205 without being vaporized when the engine is cold immediately after the start of the engine (before warming of a three-way catalyst arranged in an exhaust pipe), for example. The heater 55 and the remaining structures according to the second embodiment are the same as those according to the first embodiment, and thus description thereof is omitted. Furthermore, a heater heating treatment at the time of initial engine operation and a heater heating treatment at the time of engine restart according to the second embodiment are the same as those according to the first embodiment, and thus description thereof is omitted.

### Advantageous Effects of Second Embodiment

According to the second embodiment, the following advantageous effects are achieved.

According to the second embodiment, as described above, the tip end 251 of the port member 205b is inserted into the suction port 11 up to at least the position P1 at which the fuel F injected from the injector 3 is introduced into the intake passage 54 of the port member 205b. Accordingly, the port member 205b can be inserted up to a position on the downstream side of the suction port 11 as compared with a case in which the fuel F injected from the injector 3 is injected to the inner surface 11a of the suction port 11 downstream of the port member 205b in the intake flow direction A, and thus a range in which transfer of the heat of the cylinder head 1 to the air K in the suction port 11 can be significantly reduced or prevented (the range of the port member 205b covering the suction port 11) can be sufficiently increased. Consequently, a decrease in the density of the air K supplied to the combustion chamber 12 due to an increase in the temperature of the air K in the suction port 11 can be sufficiently significantly reduced or prevented, and thus the deterioration of the fuel efficiency due to the decrease in the density can be sufficiently significantly reduced or prevented.

According to the second embodiment, as described above, the port member 205b includes the heater 55 that vaporizes the fuel F introduced into the intake passage 54. The tip end 251 of the port member 205b is inserted up to the downstream end region En of the suction port 11 in the intake flow direction A. Accordingly, the port member 205b is inserted up to the downstream end region En of the suction port 11 such that the range in which transfer of the heat of the cylinder head 1 to the air K in the suction port 11 can be significantly reduced or prevented can be further increased, and thus transfer of the heat of the cylinder head 1 to the air K in the suction port 11 can be more sufficiently significantly reduced or prevented. Furthermore, the heater 55 is provided in the port member 205b such that the fuel F introduced into the port member 205b can be reliably vaporized. Thus, the vaporized fuel F can be supplied into the combustion chamber 12 while an increase in the temperature of the air K in the suction port 11 is more sufficiently significantly reduced or prevented, and thus combustion in the combustion chamber 12 can be maintained in a good state while the deterioration of the fuel efficiency is more sufficiently significantly reduced or prevented. Furthermore, even during the cold start of the engine E or motoring of the engine E (when the temperature in the intake passage 54 is low), for example, the fuel F attached to the inner surface 205c of the intake port 5 without being vaporized can be forcibly vaporized. Consequently, the A/F during the cold start and motoring is stable, and the fuel injection amount can be controlled to be small. Thus, supply of an excessive amount of fuel F into the combustion chamber 12 can be significantly reduced or prevented.

According to the second embodiment, the tip end 251 of the port member 205b is inserted up to a position P2 that overlaps the inlet opening 12a that communicates the combustion chamber 12 with the suction port 11 in the intake flow direction A of the suction port 11. Accordingly, the tip end 251 of the port member 205b is inserted up to the deepest portion of the suction port 11 near the inlet opening 12a such that the range in which transfer of the heat of the cylinder head 1 to the air K in the suction port 11 can be significantly reduced or prevented can be further increased. Consequently, an increase in the temperature of the air K in the suction port 11 can be further significantly reduced or prevented, and thus the deterioration of the fuel efficiency due to a decrease in the density of the air K supplied to the combustion chamber 12 can be further significantly reduced or prevented.

According to the second embodiment, as described above, in the cross-section along the intake flow direction A with the port member 205b inserted into the suction port 11, the surface 251a of the tip end 251 of the port member 205b on the inlet opening 12a side is inclined along the inclination direction of the inlet opening 12a. Accordingly, the tip end 251 of the port member 205b has a shape that fits along the shape of the inner surface 11a of the suction port 11 near the inlet opening 12a such that the port member 205b can be inserted up to the vicinity of the boundary of the suction port 11 with the inlet opening 12a. Consequently, the heat of the portion of the cylinder head 1 near the combustion chamber 12 is less likely to be transferred to the air K that flows through the intake passage 54, and thus an increase in the temperature of the air K supplied to the combustion chamber 12 can be effectively significantly reduced or prevented.

According to the second embodiment, as described above, the tip end 251 of the port member 205b includes the valve opening 59 configured to prevent interference with the intake valve 14 that opens and closes the inlet opening 12a. Accordingly, the valve opening 59 prevents interference between the port member 205b and the intake valve 14, and thus the port member 205b can be inserted up to the deepest portion of the suction port 11 near the inlet opening 12a. Consequently, the heat of the cylinder head 1 can be made difficult to be transferred to the air K that flows through the deepest portion near the inlet opening 12a.

According to the second embodiment, as described above, the valve opening 59 includes the notch. Accordingly, interference with the intake valve 14 can be prevented by a simple structure.

According to the second embodiment, as described above, the plurality of valve openings 59 are provided to correspond to the plurality of intake valves 14. Accordingly, even in the multi-cylinder engine E including the plurality of intake valves 14 in each of the plurality of suction ports 11, the valve openings 59 prevent interference between the port member 205b and the intake valves 14, and thus the port member 205b can be inserted up to the deepest portion of the suction port 11 near the inlet opening 12a.

According to the second embodiment, as described above, the heater 55 is arranged inside the inner port member 53 having a heat insulating property. Accordingly, at the time of heating of the heater 55, the inner port member 53 significantly reduces or prevents transfer of heat generated in the heater 55 to the inner port member 53, and thus escape of the heat of the heater 55 to a portion other than a desired heated portion can be significantly reduced or prevented. Consequently, the heat generated in the heater 55 can be easily and efficiently transferred to the fuel F attached to the inner surface 5a of the intake port 5, and thus the fuel F can be efficiently vaporized. The remaining advantageous effects of the second embodiment are similar to those of the first embodiment.

### MODIFIED EXAMPLES

The embodiments disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

For example, while the example in which the heater protection film 56 (heater protector) is a resin film has been shown in each of the aforementioned first and second embodiments, the present invention is not restricted to this. For example, the heater protector may be made of another material as long as the same has heat resistance, oil resistance, and chemical resistance. The heater protector may be configured by wrapping the heater with the outer port member or may be a metal tape.

While the example in which the outer port member 52 is made of polyamide 6 has been shown in each of the aforementioned first and second embodiments, the present invention is not restricted to this. In the present invention, the outer port member may be made of another material as long as the same has a heat-resistant property.

While the example in which the heater protection film 56 (heater protector) is a thin resin film having a thickness of about 0.125 mm, for example has been shown in each of the aforementioned first and second embodiments, the present invention is not restricted to this. In the present invention, the thickness of the heater protector may be different from about 0.125 mm.

While the example in which the outer port member 52 includes the partition wall 52a has been shown in each of the aforementioned first and second embodiments, the present invention is not restricted to this. For example, the outer port member may not include the partition wall.

While the example in which the inner port member 53 is formed by foam-molding polyamide has been shown in each of the aforementioned first and second embodiments, the present invention is not restricted to this. In the present invention, the inner port member is simply required to have a high heat insulating property, and may be made of glass, a melamine foam material, Gore-Tex, cellulose, a special fiber, or a resin material subjected to a plating treatment, for example.

While the example in which the heater 55 has carbon graphite or carbon nanotubes, for example, as a heat generating element containing carbon as a main component has been shown in each of the aforementioned first and second embodiments, the present invention is not restricted to this. In the present invention, the heater may be a ceramic heater, a silicone rubber heater, or a stainless steel heater, for example.

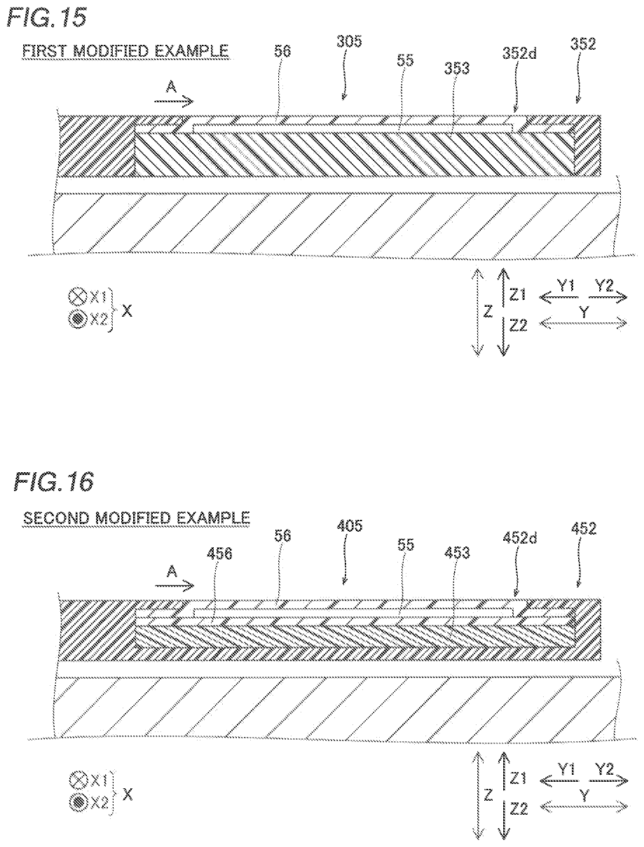

While the example in which the internal structure of the intake port 5 (205) is four-layered has been shown in each of the aforementioned first and second embodiments, the present invention is not restricted to this. In the present invention, the internal structure of an intake port 305 may be three-layered as in a first modified example shown in FIG. 15. That is, instead of the embedded recess, a through-hole 352d that passes through an outer port member 352 may be formed in the outer port member 352, and a structure in which a heater protection film 56, a heater 55, and an inner port member 353 are stacked while being in surface contact with each other may be embedded in the through-hole 352d. Alternatively, the internal structure of an intake port 405 may be five-layered as in a second modified example shown in FIG. 16. That is, a heater protection film 56, a heater 55, a heater protection film 456, an inner port member 453, and an outer port member 452 may be stacked in an embedded recess 452d of the outer port member 452 while being in surface contact with each other.

While the example in which the injector opening 58 passes through the outer port member 52 in the direction (Z direction) orthogonal to the intake flow direction A has been shown in each of the aforementioned first and second embodiments, the present invention is not restricted to this. In the present invention, the injector opening may have a notch shape in which the outer port member is cut out along the intake flow direction.

While the example in which the controller 10 includes the ECU including the CPU and the memory has been shown in each of the aforementioned first and second embodiments, the present invention is not restricted to this. For example, the controller may include a dedicated control circuit that controls the temperature of the heater other than the ECU.

While the example in which the process operations performed by the controller 10 are described using a flowchart in a flow-driven manner in which processes are performed in order along a process flow for the convenience of illustration in each of the aforementioned first and second embodiments, the present invention is not restricted to this. In the present invention, the process operations performed by the controller may be performed in an event-driven manner in which the processes are performed on an event basis. In this case, the process operations performed by the controller may be performed in a complete event-driven manner or in a combination of an event-driven manner and a flow-driven manner.

While the example in which the intake port 5 (205) (the air intake apparatus for an internal combustion engine) and the intake manifold 4 are separated from each other has been shown in each of the aforementioned first and second embodiments, the present invention is not restricted to this. In the present invention, the air intake apparatus for an internal combustion engine may be joined integrally with the intake manifold by welding, for example.

While the example in which the valve opening 59 (relief) includes the notch that is open in the Z1 direction and in the direction along the intake flow direction A has been shown in each of the aforementioned first and second embodiments, the present invention is not restricted to this. In the present invention, the relief may include an opening that is open in the Z1 direction.

While the example in which the tip end 251 of the port member 205b is inserted up to the downstream end region En of the suction port 11 in the intake flow direction A has been shown in the aforementioned second embodiment, the present invention is not restricted to this. In the present invention, the tip end of the port member may be inserted up to a position between the position at which the fuel injected from the injector is introduced into the intake passage of the port member and the downstream end region.

While the example in which the tip end 251 of the port member 205b is inserted up to the position P2 that overlaps the inlet opening 12a in the intake flow direction A of the suction port 11 has been shown in the aforementioned second embodiment, the present invention is not restricted to this. In the present invention, the tip end of the port member may be inserted up to a position between the position at which the fuel injected from the injector is introduced into the intake passage of the port member and the position that overlaps the inlet opening.

While the example in which in the cross-section along the intake flow direction A with the port member 205b inserted into the suction port 11, the surface 251a of the tip end 251 of the port member 205b on the inlet opening 12a side is inclined along the inclination direction of the inlet opening 12a has been shown in the aforementioned second embodiment, the present invention is not restricted to this. In the present invention, a surface of the tip end of the port member on the inlet opening side may be inclined along a direction away from the inlet opening.

### DESCRIPTION OF REFERENCE NUMERALS

1: cylinder head
2: cylinder
3: injector
5, 205, 305, 405: intake port (air intake apparatus for an internal combustion engine)
7: planar heater
11: suction port
11a: inner surface of the suction port
12: combustion chamber
12a: inlet opening
14: intake valve
52, 352, 452: outer port member
52b: inner surface of the outer port member
52d, 452d: embedded recess (recess)
53, 353, 453: inner port member
54: intake passage
55: heater
56, 456: heater protection film (heater protector)
58: injector opening (opening, injector opening)
59: valve opening (relief)
205b: port member
251: tip end
251a: surface
352d: through-hole
A: intake flow direction
E: engine (internal combustion engine)
En: downstream end region
F: fuel
K: air
M: air-fuel mixture
P1: position
P2: position

1. An air intake apparatus for an internal combustion engine, the air intake apparatus comprising:
an outer port member inserted into a suction port in a cylinder head, the outer port member facing an inner surface of the suction port;
an inner port member arranged inside the outer port member;
an intake passage formed inside the outer port member and the inner port member, the intake passage being configured to allow an air-fuel mixture containing air and fuel supplied to a cylinder to flow therethrough; and
a heater arranged inside the inner port member; wherein
the inner port member is stacked on an outside of the heater in a direction orthogonal to an intake flow direction of the suction port, and is configured to insulate heat from the heater.

2. The air intake apparatus for an internal combustion engine according to claim 1, further comprising:
a heater protector configured to cover the heater from a side of the intake passage; wherein
the heater protector has a lower heat insulating property than that of the inner port member.

3. The air intake apparatus for an internal combustion engine according to claim 2, wherein the heater protector, the heater, the inner port member, and the outer port member are stacked in this order in the direction orthogonal to the intake flow direction of the suction port.

4. The air intake apparatus for an internal combustion engine according to claim 3, wherein
the outer port member includes a recess formed by recessing an inner surface thereof in the direction orthogonal to the intake flow direction of the suction port; and
the heater protector, the heater, and the inner port member are embedded in the recess of the outer port member while the heater protector, the heater, and the inner port member are stacked in this order in the direction orthogonal to the intake flow direction of the suction port.

5. The air intake apparatus for an internal combustion engine according to claim 1, wherein each of the outer port member and the inner port member includes an opening configured to allow fuel injected from an injector to be introduced therethrough, the injector supplying the fuel to the suction port.

6. The air intake apparatus for an internal combustion engine according to claim 5, wherein the heater includes a planar heater provided along an inner surface of the inner port member, the planar heater having an open portion corresponding to a portion of the inner port member with the opening formed.

7. The air intake apparatus for an internal combustion engine according to claim 1, wherein a tip end of the outer port member is inserted into the suction port up to at least a position at which fuel injected from an injector configured to supply the fuel to the suction port is introduced into the intake passage.

8. An air intake apparatus for an internal combustion engine, the air intake apparatus comprising:
a port member inserted into a suction port in a cylinder head with an injector attached thereto; and
an intake passage formed inside the port member, the intake passage being configured to allow an air-fuel mixture containing air and fuel supplied to a cylinder to flow therethrough; wherein
a tip end of the port member is inserted into the suction port up to at least a position at which fuel injected from an injector is introduced into the intake passage of the port member.

9. The air intake apparatus for an internal combustion engine according to claim 8, further comprising:
a heater provided in the port member, the heater being configured to vaporize the fuel introduced into the intake passage; wherein
the tip end of the port member is inserted up to a downstream end region of the suction port in an intake flow direction.

10. The air intake apparatus for an internal combustion engine according to claim 9, wherein the tip end of the port member is inserted up to a position that overlaps an inlet opening configured to communicate a combustion chamber with the suction port in the intake flow direction of the suction port.

11. The air intake apparatus for an internal combustion engine according to claim 10, wherein in a cross-section along the intake flow direction with the port member inserted into the suction port, a surface of the tip end of the port member on a side of the inlet opening is inclined along an inclination direction of the inlet opening.

12. The air intake apparatus for an internal combustion engine according to claim 10, wherein the tip end of the port member includes a relief configured to prevent interference with an intake valve configured to open and close the inlet opening.

13. The air intake apparatus for an internal combustion engine according to claim 8, wherein the port member includes an injector opening configured to allow the fuel injected from the injector to be introduced into the intake passage.

14. The air intake apparatus for an internal combustion engine according to claim 9, wherein
the port member includes an outer port member, and an inner port member having a heat insulating property; and
the heater is arranged inside the inner port member.
